(19) United States
(12) Patent Application Publication
(10) Pub. No.: US 2023/0219776 A1
(43) Pub. Date: Jul. 13, 2023

(54) SHEET FEEDING APPARATUS AND IMAGE FORMING SYSTEM

(71) Applicant: CANON KABUSHIKI KAISHA, Tokyo (JP)

(72) Inventor: SHINGO IWAMI, Tokyo (JP)

(21) Appl. No.: 18/150,705

(22) Filed: Jan. 5, 2023

(30) Foreign Application Priority Data
Jan. 13, 2022 (JP) 2022-003466

(51) Int. Cl. B65H 3/48; B65H 7/16

(52) U.S. Cl. CPC B65H 3/48; B65H 7/16; B65H 2801/06

(57) ABSTRACT

A sheet feeding apparatus includes a sheet supporting portion, a sheet feed portion, an air separation unit, and a control unit. The sheet supporting portion supports a sheet bundle. The sheet feed portion performs a sheet feeding operation by abutting against an uppermost sheet of the sheet bundle supported on the sheet supporting portion and feeding the uppermost sheet. The air separation unit performs an air blowing operation of blowing air to a side face of the sheet bundle supported on the sheet supporting portion and separating sheets. The control unit executes a mode of performing the air blowing operation by the air separation unit, stopping the air blowing operation, and then performing the sheet feeding operation by the sheet feed portion in a state where the air blowing operation is stopped.

### BACKGROUND

### Field

The present disclosure relates to a sheet feeding apparatus that performs an air blowing operation in which air is blown to separate sheets, and an image forming system.

### Description of the Related Art

Image forming apparatuses such as coping machines, facsimile machines and printers or image forming systems equipped with such image forming apparatuses include a sheet feeding apparatus such as a sheet feed cassette or a sheet feed deck in which a bundle of sheets to be supplied to the image forming unit for forming images are set. There are growing demands for forming images on various types of sheets, and for example, sheets such as coated paper with a smooth surface property are used as the recording material. If a bundle of sheets having such smooth surface property is set in the sheet feeding apparatus, the sheets may be adhered to one another, and feeding of sheets may become difficult. Therefore, a technique is proposed in which air is blown to the sheet bundle to lift the sheets and thereby separate the sheets (refer to Japanese Patent Application Laid-Open Publication No. H04-23747).

A general control of a technique of blowing air to the bundle of sheets to thereby separate the sheets while feeding the sheets as disclosed in Japanese Patent Application Laid-Open Publication No. H04-23747 will be described with reference to FIG. 15. As illustrated in FIG. 15, when a control for feeding sheets is started in response to a command for starting a print job (S101), at first, air blow toward the bundle of sheets is started (S102). Blowing of air is continued until a predetermined time, such as 10 seconds, has elapsed from the starting of air blow (S103: No). Next, when a predetermined time has elapsed from the starting of air blow (S103: Yes), a sheet feeding operation of feeding sheets to the image forming unit by a pickup roller and the like is performed (S104). Then, the sheet feeding operation is repeated until a necessary number of sheets to be fed to the image forming unit based on a print job command is achieved (S105: No), and when the necessary number of sheets has been reached (S105: Yes), blowing of air is stopped (S106), and the present control is ended (S107).

However, when feeding of sheets is performed while blowing air, as according to the above-described control, the sheets are lifted up, such that the edge portions of the sheets are easily curled. Therefore, even if the position of sheets in the width direction is regulated by a regulating plate, there is a drawback that the curling of the sheet may cause skewing of the sheet when a rotating force is applied to the sheet.

### SUMMARY

According to an aspect of the present disclosure, a sheet feeding apparatus includes a sheet supporting portion configured to support a sheet bundle, a sheet feed portion configured to perform a sheet feeding operation by abutting against an uppermost sheet of the sheet bundle supported on the sheet supporting portion and feeding the uppermost sheet, an air separation unit configured to perform an air blowing operation of blowing air to a side face of the sheet bundle supported on the sheet supporting portion and separating sheets, and a control unit configured to execute a mode of performing the air blowing operation by the air separation unit, stopping the air blowing operation, and then performing the sheet feeding operation by the sheet feed portion in a state where the air blowing operation is stopped.

Further features of the present disclosure will become apparent from the following description of exemplary embodiments with reference to the attached drawings.

### BRIEF DESCRIPTION OF THE DRAWINGS

FIG. 1 is a view illustrating a schematic configuration of an image forming system according to a first embodiment.

FIG. 2 is a block diagram illustrating a control system of the image forming system according to the first embodiment.

FIG. 3 is a schematic diagram illustrating a configuration of a sheet feed deck according to the first embodiment.

FIG. 4 is a schematic diagram illustrating a state in which an air blowing operation is performed in a sheet feed deck according to the first embodiment.

FIG. 5 is a flowchart illustrating a sheet feed control according to the first embodiment.

FIG. 6 is a graph illustrating a relationship between number of sheets being fed and amount of skew in a case where sheets are fed based on the sheet feed control according to the first embodiment and a case where sheets are fed while the air blowing operation is continued.

FIG. 7 is a flowchart illustrating a sheet feed control according to a second embodiment.

FIG. 8 is a flowchart illustrating a sheet feed control according to a third embodiment.

FIG. 9 is a graph illustrating a relationship between a number of sheets being fed and a feed time to a sheet detection sensor according to the third embodiment.

FIG. 10 is a flowchart illustrating a sheet feed control according to a fourth embodiment.

FIG. 11 is a graph illustrating a relationship between a number of sheets being fed and a motor torque of a feed motor according to the fourth embodiment.

FIG. 12 is a flowchart illustrating a sheet feed control according to a fifth embodiment.

FIG. 13 is a view illustrating a mode selection screen according to the fifth embodiment.

FIG. 14 is an explanatory view illustrating the occurrence of a turning force based on a positional relationship between a pickup roller and a feed roller.

FIG. 15 is a flowchart illustrating a general sheet feed control.

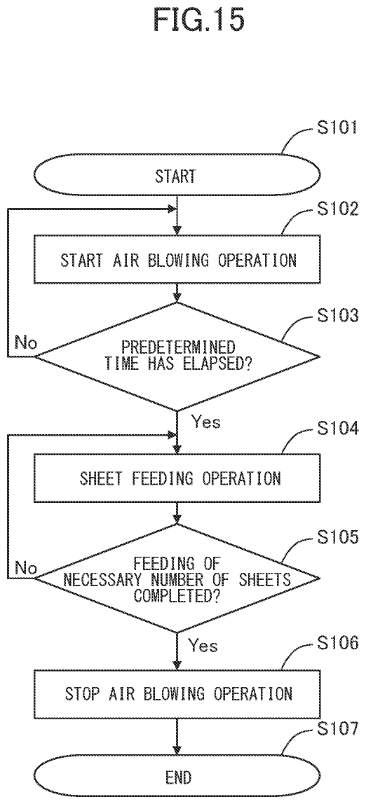

### DESCRIPTION OF THE EMBODIMENTS

### First Embodiment

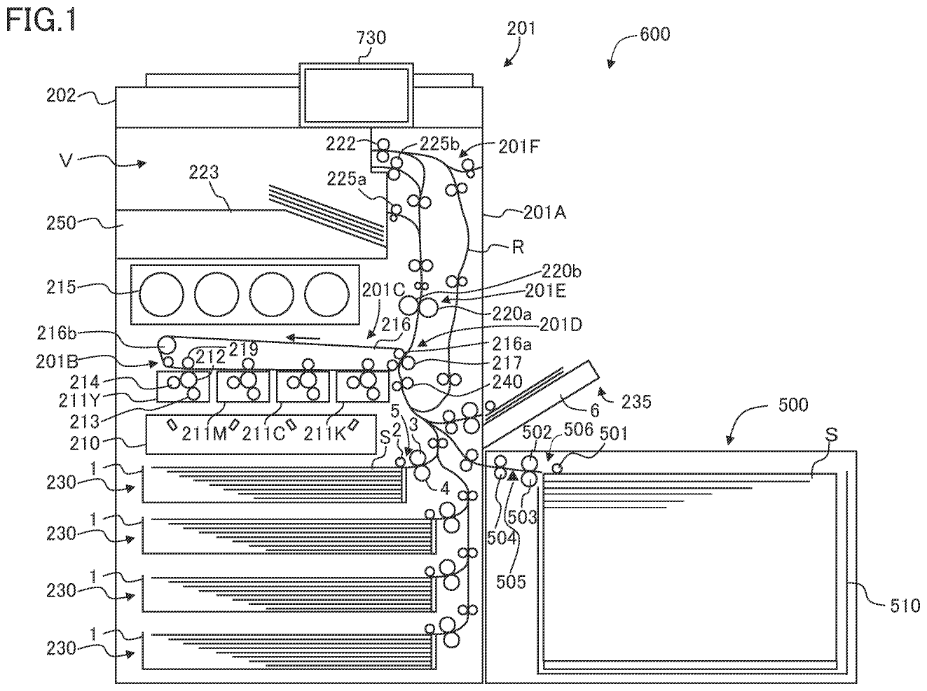

Now, a first embodiment according to a present disclosure will be described in detail with reference to the drawings. At first, an image forming system 600 equipped with a sheet feed deck 500 serving as a sheet feeding apparatus according to the present disclosure and an image forming apparatus 201 connected thereto will be described with reference to FIG. 1. FIG. 1 is a view illustrating a schematic configuration of an image forming system according to a first embodiment.

### Schematic Configuration of Image Forming System

As illustrated in FIG. 1, the image forming system 600 is equipped with the image forming apparatus 201 and the sheet feed deck 500 connected to the image forming apparatus 201. The sheet feed deck 500 serving as a sheet feeding apparatus is connected to a right side in FIG. 1 of the image forming apparatus 201, and it is configured to enable sheets S to be fed to the image forming apparatus 201.

### Schematic Configuration of Image Forming Apparatus

In FIG. 1, reference number 201 denotes an image forming apparatus, 201A denotes an image forming apparatus body, and 201B denotes an image forming unit for forming images on sheets. Reference number 202 denotes an image reading apparatus arranged approximately horizontally at an upper area of the image forming apparatus body 201A, and a sheet discharge space V to which sheets are discharged is formed between the image reading apparatus 202 and the image forming apparatus body 201A. Further, an operation unit 730 composed, for example, of a touch panel capable of displaying a screen thereon is arranged at an upper area of the image forming apparatus body 201A.

The image forming unit 201B is a four-drum full-color system. The image forming unit 201B includes a laser scanner 210, and four process cartridges 211Y, 211M, 211C, and 211K that form toner images of four colors, which are yellow (Y), magenta (M), cyan (C), and black (K). Each of the process cartridges 211 includes a photosensitive drum 212, a charger 213 serving as a charge unit, and a developing device 214 serving as a developing unit. Further, the image forming unit 201B includes an intermediate transfer unit 201C arranged above the process cartridges 211, and a fixing unit 201E. Reference number 215 denotes a toner cartridge through which toner is supplied to each developing device 214.

The intermediate transfer unit 201C includes an intermediate transfer belt 216 suspended around a driving roller 216a and a tension roller 216b. A primary transfer roller 219 is arranged on an inner side of the intermediate transfer belt 216 at a position opposed to the photosensitive drum 212 and abutted against the intermediate transfer belt 216. The intermediate transfer belt 216 rotates in an arrow direction by the driving roller 216a that is driven by a driving unit not shown.

Toner images having negative polarity of various colors formed on the photosensitive drums are sequentially transferred in multiple layers on the intermediate transfer belt 216 by the primary transfer rollers 219. A secondary transfer roller 217 for transferring a color image formed on the intermediate transfer belt to the sheet S is provided at a position opposed to the driving roller 216a of the intermediate transfer unit 201C. A secondary transfer portion 201D is formed between the intermediate transfer belt 216 and the secondary transfer roller 217. Further, the fixing unit 201E including a pressure roller 220a and a heating roller 220b is arranged above the secondary transfer roller 217. Further, a first sheet discharge roller pair 225a, a second sheet discharge roller pair 225b, and a duplex reverse portion 201F are arranged on an upper left portion of the fixing unit 201E. A reverse conveyance roller pair 222 capable of being rotated in normal and reverse directions and a reconveyance path R for conveying the sheet having an image formed on a first surface thereof to the image forming unit 201B again are provided in the duplex reverse portion 201F.

A sheet feed unit 230 for sending out the sheet S set therein toward the image forming unit 201B is provided at a lower portion of the image forming apparatus body 201A. The sheet feed unit 230 includes a sheet feed cassette 1 for storing sheets, and a sheet feed portion 5 for feeding the sheets S stored in the sheet feed cassette 1. The sheet feed portion 5 is equipped with a pickup roller 2, and a feed roller 3 and a retard roller serving as a separation unit for separating the sheets S that have been fed in a multi-feed manner by the pickup roller 2.

Further, a manual sheet feed portion 235 for sending the sheets S being set therein toward the image forming unit 201B is provided at a right-side face in FIG. 1 of the image forming apparatus body 201A. The manual sheet feed portion 235 is equipped with a manual feed tray 6 for supporting the sheets S, and it is also equipped with a sheet feed unit and a separation unit, similar to the sheet feed unit 230. Further, the sheet feed deck 500 for sending the sheets S set therein toward the image forming unit 201B is provided on the right-side face of FIG. 1 of the image forming apparatus body 201A below the manual sheet feed portion 235. The details of the sheet feed deck 500 will be described later. The sheet feed deck 500, the sheet feed unit 230, the manual sheet feed portion 235, and a control unit 100 described below constitute a sheet feeding apparatus for feeding the sheets to the image forming unit.

Next, an image forming operation of the image forming apparatus 201 will be described. First, in a state where an image information of a document is read by the image reading apparatus 202, the image information is subjected to image processing, converted into electric signals, and transmitted to the laser scanner 210 of the image forming unit 201B. In the image forming unit 201B, surfaces of the photosensitive drums 212 which are charged uniformly to predetermined polarity and potential by the chargers 213 are sequentially exposed by laser light. Thereby, electrostatic latent images of yellow, magenta, cyan, and black are sequentially formed on the photosensitive drums of the respective process cartridges 211.

Then, the electrostatic latent images are developed and visualized respectively by color toner and visualized, and the toner images of respective colors on the photosensitive drums are transferred sequentially in an overlapped manner on the intermediate transfer belt 216 by a primary transfer bias applied to the primary transfer roller 219. Thereby, a toner image is formed on the intermediate transfer belt 216.

Meanwhile, the sheet S fed by the feed roller 3 of the sheet feed unit 230 is conveyed to a registration roller pair 240 composed of a driving roller and a driven roller. In this state, the driving of the registration roller pair 240 is stopped, and the leading edge of the sheet S is abutted against the registration roller pair 240. Thereby, the leading edge of the sheet S is aligned along the registration roller pair 240. Thereafter, the feed roller 3 continues to convey the sheet S, by which the sheet S is deflected, or looped, and when a predetermined amount of looping is formed, the registration roller pair 240 is driven. Thereby, skewing of the sheet S is corrected by the registration roller pair 240, and the sheet S subjected to skew correction is conveyed by the registration roller pair 240 to the secondary transfer portion 201D. Next, in the secondary transfer portion 201D, the toner image is collectively transferred to the sheet S by a secondary transfer bias applied to the secondary transfer roller 217. Then, the sheet S having a toner image transferred thereto is conveyed to the fixing unit 201E, and the heat and pressure applied at the fixing unit 201E enable the multiple toner colors to be melted, mixed, and fixed as a colored image on the sheet S.

Thereafter, the sheet S on which the image has been fixed is discharged to the sheet discharge space V by the first sheet discharge roller pair 225a and the second sheet discharge roller pair 225b disposed downstream of the fixing unit 201E, and supported on a supporting portion 223 formed on a bottom side of the sheet discharge space V. When forming images on both sides of the sheet S, the sheet S to which an image has been fixed is conveyed by the reverse conveyance roller pair 222 to the reconveyance path R and conveyed again to the image forming unit 201B.

### Configuration of Sheet Feed Deck

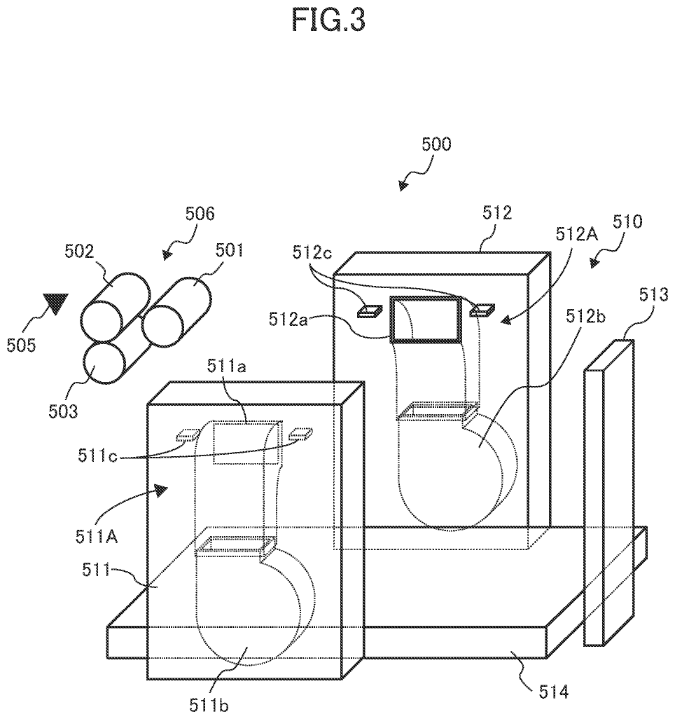

Next, the details of the sheet feed deck 500 serving as a sheet feeding apparatus will be described with reference to FIGS. 1 and 3. FIG. 3 is a schematic diagram illustrating a configuration of the sheet feed deck according to the first embodiment.

As illustrated in FIG. 1, the sheet feed deck 500 is a large capacity loading-type sheet feeding apparatus capable of loading a large amount of sheets S, the number being greater than the capacity of load of sheets S in the sheet feed cassette 1 of the image forming apparatus 201, on a lifter plate 514 and subjecting the sheets to continuous feeding. The sheet feed deck 500 includes, as illustrated in FIGS. 1 and 3, a deck portion 510 serving as a sheet storage portion, and a sheet feed portion 506 that feeds sheets and also separates multi-feed sheets. Further, the sheet feed portion 506 is equipped with a pickup roller 501 serving as a sheet feed roller that abuts against an uppermost sheet of the sheet bundle supported on the lifter plate 514 described below and feeds the uppermost sheet. Further, the sheet feed portion 506 includes a feed roller 502 and a retard roller 503 that serve as a separation portion for separating the sheets S fed by the pickup roller 501. Further, the sheet feed deck 500 includes a drawing roller 504 positioned downstream in the sheet conveyance direction of the feed roller 502 for drawing out the sheet S from the feed roller 502 and feeds the same to the image forming apparatus 201. Further, a sheet feed sensor 505 serving as a sheet detection unit is arranged between the feed roller 502 and the drawing roller 504 in the sheet feeding direction, that is, downstream in the sheet feeding direction of the sheet feed portion 506. The sheet feed sensor 505 detects the passing of the sheet S by outputting a signal corresponding to presence/absence of the sheet S.

Further, as illustrated in FIG. 3, the lifter plate 514 serving as a sheet supporting portion for stacking and supporting a sheet bundle composed of a plurality of sheets S is provided in the deck portion 510. A position of the lifter plate 514 in a height direction is controlled according to a stacked amount of the sheet S by a lifting mechanism not shown. Further, as illustrated in FIG. 3, side edge regulating plates 511 and 512 and a trailing edge regulating plate 513 are provided in the deck portion 510. The side edge regulating plates 511 and 512 regulate positions of edge portions of the sheet S in the width direction, i.e., side edges of the sheet, set on the lifter plate 514. The trailing edge regulating plate 513 regulates an upstream edge position, i.e., trailing edge, of the sheet S in a sheet feeding direction.

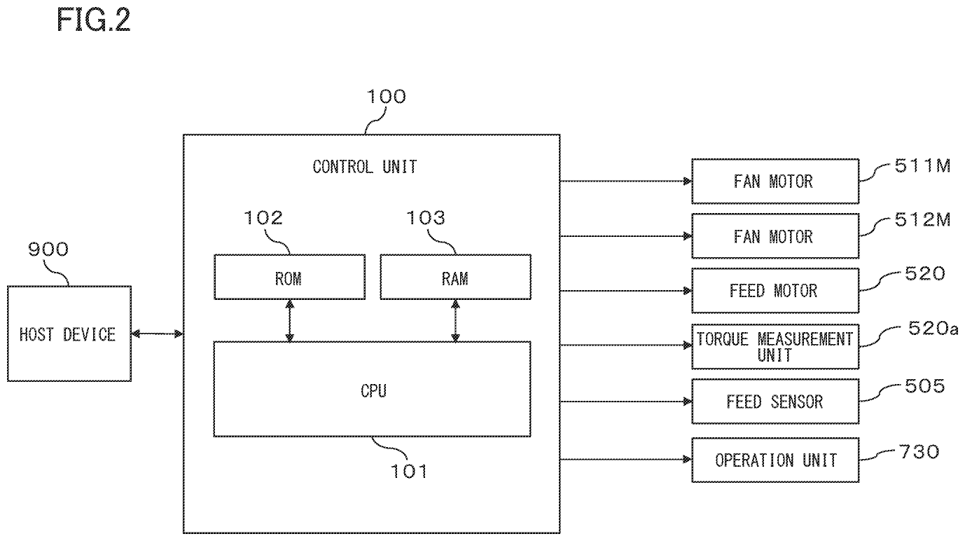

The side edge regulating plates 511 and 512 are respectively provided with air blow units 511A and 512A serving as an air separation unit. The air blow unit 511A of the side edge regulating plate 511 includes a fan 511b driven by a fan motor 511M (refer to FIG. 2) and an air blowing nozzle 511a that guides air sent from the fan 511b and blows air toward a side of the sheet bundle. Similarly, the air blow unit 512A of the side edge regulating plate 512 includes a fan 512b driven by a fan motor 512M (refer to FIG. 2) and an air blowing nozzle 512a that guides air sent from the fan 512b and blows air toward a side of the sheet bundle. The side edge regulating plates 511 and 512 are further provided with lift suppressing plates 511c and 512c arranged near the air blowing nozzles 511a and 512a that prevent the sheets S toward which air has been blown from lifting up beyond the side edge regulating plates 511 and 512.

### Control Configuration of Image Forming System

Next, a configuration of a control system according to the image forming system 600 will be described with reference to FIG. 2. FIG. 2 is a block diagram illustrating a control system of an image forming system according to the first embodiment.

The control unit 100 according to the present embodiment is provided in the image forming apparatus 201, for example, and includes a CPU 101, a ROM 102, and a RAM 103. The control unit 100 is a control unit that controls the image forming apparatus 201 and the sheet feed deck 500 in an integrated manner. The control unit 100 is connected to a host device 900 and the operation unit 730, communicates information therewith, and performs signal processing to various processing apparatuses and sequence control. The host device 900 is an external apparatus, such as a personal computer, an image scanner, or a facsimile.

Further, the control unit 100 is connected to a feed motor 520 serving as a motor for driving the fan motors 511M and 512M and the pickup roller 501, a torque measurement unit 520a for measuring a motor torque of the feed motor 520, and the sheet feed sensor 505. The torque measurement unit 520a measures the motor torque of the feed motor 520, but for example, it can also be a current sensor for detecting the current value flowing to the feed motor 520 or a torque sensor for detecting the torque generated in the pickup roller 501. In other words, any configuration capable of measuring the motor torque of the feed motor 520 can be adopted as the torque measurement unit 520a.

### Operation for Blowing Air and Problems

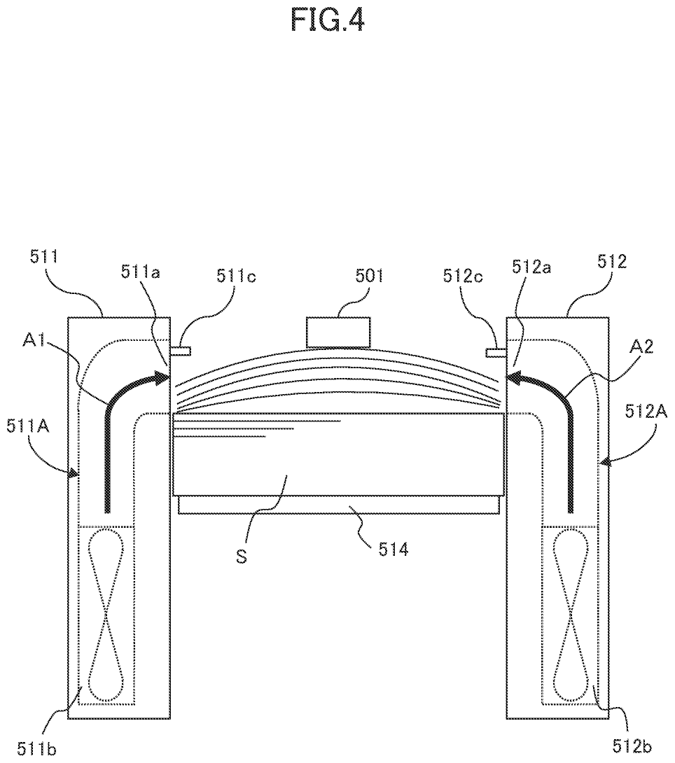

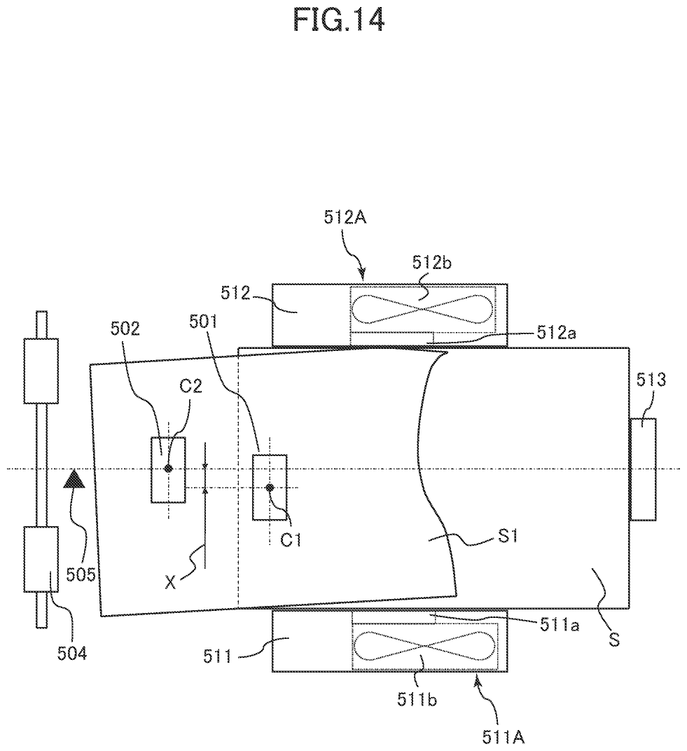

Next, a state of the sheet S in a state where air is blown from the sides of the sheet bundle by the air blow units 511A and 512A and issues related to feeding the sheets S while continuing air blow will be described with reference to FIGS. 4 and 14. FIG. 4 is a schematic diagram illustrating a state in which an operation of blowing air, hereinafter referred to as an air blowing operation, is performed in the sheet feed deck according to the first embodiment. Further, FIG. 14 is an explanatory view illustrating the occurrence of a turning force caused by a positional relationship between the pickup roller and the feed roller.

As illustrated in FIG. 4, air is blown toward the side faces of the sheet bundle from the fans 511b and 512b of the air blow units 511A and 512A, as shown by arrows A1 and A2. Then, a few to tens of sheets S on the upper part of the sheet bundle are separated and lifted up by the air, while the lift suppressing plates 511c and 512c suppresses lifting of the sheets S. Thereby, adhesion between the sheets S is reduced, such that the pickup roller 501 can feed even the sheets S having a smooth surface property, such as coated paper.

There is a case in which a center C1 of the pickup roller 501 and a center C2 of the feed roller 502 are deviated by distance X in a width direction orthogonal to a sheet feeding direction, as illustrated in FIG. 14. In this case, if a conveyance load occurs in the vicinity of the pickup roller 501 during conveyance of an uppermost sheet S1 by the feed roller 502 due to a difference of conveyance speed, for example, a turning force in a counterclockwise direction occurs to the sheet S1. Therefore, the sheet S1 is conveyed while being turned, such that skewing of the sheet S1 occurs. Even if such turning force occurs to the sheet S1, usually, the side edges of the sheet S1 abut against the side edge regulating plates 511 and 512, and skewing of the sheet S1 is suppressed due to the stiffness of the sheet. However, since the sheet S1 is lifted by the air blown from the air blow units 511A and 512A, the sheet S1 tends to be deflected, as illustrated in FIG. 14. Therefore, the effect of suppressing skewing of the sheet S1 by the side edge regulating plates 511 and 512 is reduced, and the amount of skewing of the sheet S1 tends to increase. Therefore, sheet feed control is performed as described below according to the first embodiment.

### Sheet Feed Control According to First Embodiment

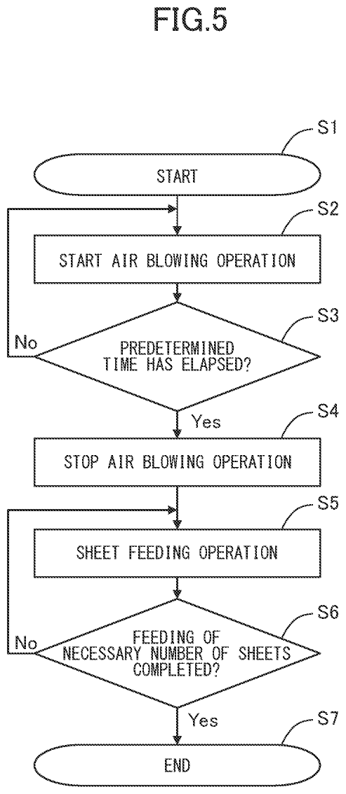

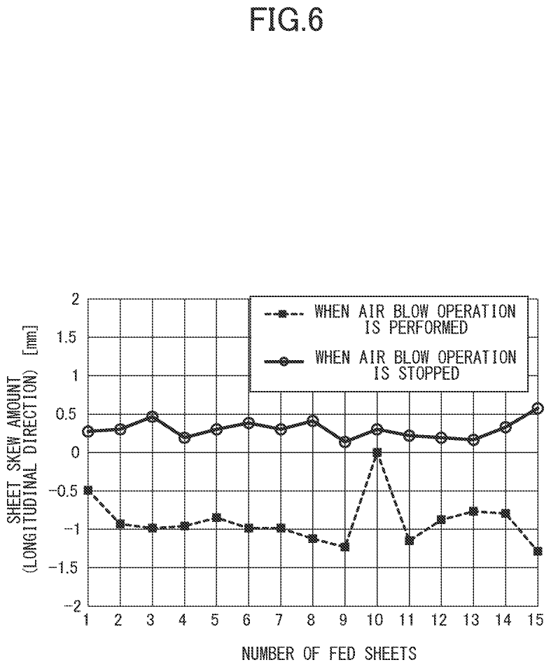

Next, a sheet feed control according to the first embodiment will be described with reference to FIGS. 5 and 6. FIG. 5 is a flowchart illustrating a sheet feed control according to the first embodiment. FIG. 6 is a graph illustrating a relationship between the number of sheets being fed and the skew amount in a case where the sheets are fed according to the sheet feed control of the first embodiment and a case where the sheets are fed while continuing the air blowing operation.

The control unit 100 starts a sheet feed control, or sheet feed control mode, to feed 15 sheets, for example, as the number of sheets required to be printed in the image forming apparatus 201 (S1). At first, an air blowing operation is started in which the fan motors 511M and 512M (refer to FIG. 2) of the air blow units 511A and 512A are driven to blow air to the side faces of the sheet bundle (S2). Thereby, a few to tens of sheets S on an upper part of the sheet bundle are separated and lifted while the lift suppressing plates 511c and 512c suppress lifting of the sheets S (refer to FIG. 4), such that adhesion between sheets is reduced.

Since the fan motors 511M and 512M start to rotate from a rotation stopped state, a predetermined time such as 10 seconds is set in advance as the time required for the fans to reach a desired rotational speed and for the lifting of the sheets S to stabilize. Then, the air blowing operation is performed until a predetermined time has elapsed (S3: No), and when the predetermined time has elapsed (S3: Yes), the air blowing operation is stopped (S4), that is, the drive of the fan motors 511M and 512M is turned off. Thereby, the sheet Sin the lifted state gradually returns to the sheet bundle state prior to being lifted by the air between the sheets being released, but the adhesion between the sheets is still low until the sheet bundle resumes its state, so that the sheet feeding operation of the sheets S is started (S5).

The starting of the sheet feeding operation refers to a state in which the sheet S is fed by the pickup roller 501 in the state abutted against the uppermost sheet S of the sheet bundle being rotated by the drive supplied from the feed motor 520. Thereafter, a sequence of operations is performed in which sheets S are separated at a separation portion between the feed roller 502 and the retard roller 503 if multi-feeding of the sheets S occurs, and the passing of the sheet is detected by the sheet feed sensor 505. Then, according to the first embodiment, the sheet feeding operation is repeated until the feeding of 15 sheets S as the necessary number of sheets is completed (S6: No), and if the feeding of the necessary number of sheets is completed (S6: Yes), the sheet feed control is ended (S7).

The relationship between the number of sheets being fed and the skew amount in a case where 15 sheets are fed according to the sheet feed control of the first embodiment and a case where the sheets are fed while continuing the air blowing operation will be described. FIG. 6 illustrates a transition of a skew amount in a longitudinal direction, that is, amount of inclination with respect to the conveyance direction, for each of the 15 sheets fed from the sheet feed deck 500. The sheets are coated paper (product name: OK Topcoat+, Product of Oji Paper Co., Ltd., 104.7 g/m² A3 Y), and during the air blowing operation, air is blown from both sides to the sheet bundle (refer to FIG. 4). Further, the fan motors 511M and 512M are controlled by PWM control, and a φ97 mm blower fan is used as each of the fans 511b and 512b, wherein air is blown with a PWM duty ratio of 40% during the air blowing operation.

If a sheet feeding operation is performed during the air blowing operation, that is, if the sheet feeding operation is performed while continuing the air blowing operation and having air blown to the sheets, there is a high dispersion (average deviation σ=0.32) in the skew amount per sheet being fed. Amount of inclination (average value=−0.89) is also increased. Meanwhile, if the sheet feeding operation is performed after stopping the air blowing operation, as in the sheet feed control according to the present first embodiment, it is recognized that the skew amount is stabilized (average deviation σ=0.12) and that the skew amount (average value=0.30) is small.

As described, according to the sheet feed control of the first embodiment, even when using a sheet having a smooth surface property, such as coated paper, adhesion can be reduced by separating a few to tens of sheets on the upper part of the sheet bundle by the air blowing operation. Thereby, for example, it becomes possible to prevent the pickup roller 501 from slipping and being unable to convey sheets, and to enable feeding of sheets that have a high adhesion between sheets. The sheet feeding operation is performed after stopping the air blowing operation, such that compared to a case where the sheet feeding operation is performed while continuing the air blowing operation, the skew amount of sheets fed from the sheet feed deck 500 can be improved. Therefore, the amount of skew correction required during correction of skewing of the sheet by the registration roller pair 240 is reduced, such that the dispersion of sheet position being conveyed to the secondary transfer portion 201D can be reduced, and the printing accuracy, or quality, can be improved.

### Second Embodiment

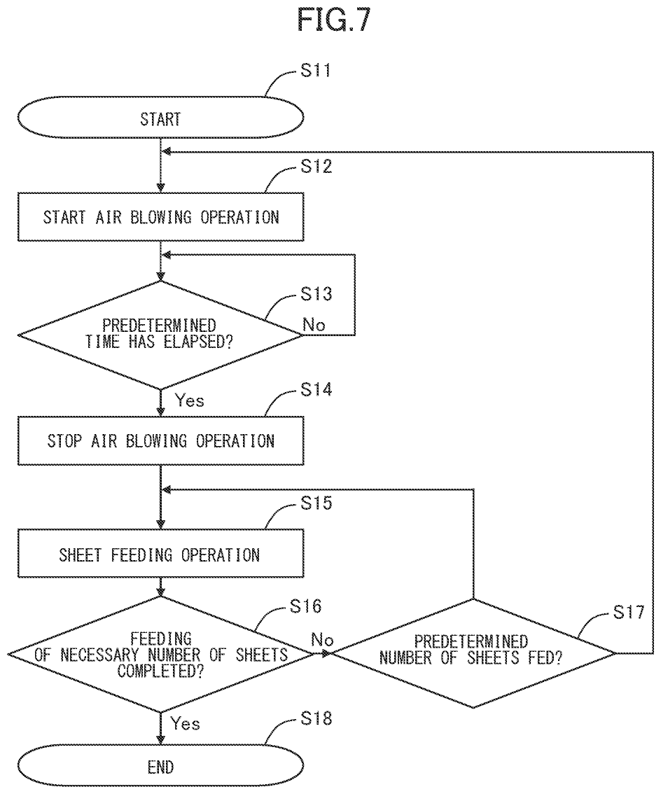

Next, a second embodiment in which a part of the first embodiment has been altered will be described with reference to FIG. 7. FIG. 7 is a flowchart illustrating a sheet feed control according to a second embodiment. In the description of the second embodiment, the same reference numbers are used to denote similar portions as the first embodiment, and descriptions thereof are omitted.

The second embodiment illustrates a case in which 50 sheets are fed, for example, as the required number of sheets to be printed by the image forming apparatus 201. As described above, when performing the air blowing operation, a few to tens of sheets on the upper part of the sheet bundle are separated and lifted, as illustrated in FIG. 4, and adhesion between sheets is reduced. Even though the number of sheets being lifted varies according to the positions of the air blowing nozzles 511a and 512a or the positions of the lift suppressing plates 511c and 512c, the number of sheets that are lifted by one air blowing operation is limited to approximately a few to tens of sheets. In the description of the second embodiment, it is assumed that the number of sheets being separated by one air blowing operation is 10 sheets. Therefore, when 50 sheets are fed, the adhesion between sheets of all 50 sheets cannot be reduced in one air blowing operation. The following description illustrates the sheet feed control according to the second embodiment.

### Sheet Feed Control According to Second Embodiment

The control unit 100 starts sheet feed control to feed 50 sheets, for example, as the required number of sheets to be printed by the image forming apparatus 201 (S11). At first, an air blowing operation is started in which the fan motors 511M and 512M (refer to FIG. 2) of the air blow units 511A and 512A are driven to blow air to the side faces of the sheet bundle (S12). Thereby, 10 sheets S at the upper part of the sheet bundle are separated and lifted while the lift suppressing plates 511c and 512c suppress lifting of the sheets S (refer to FIG. 4), such that adhesion between the sheets is reduced.

Next, the air blowing operation is performed until a predetermined time has elapsed (S13: No), and after a predetermined time has elapsed (S13: Yes), the air blowing operation is stopped (S14). Thereby, the sheet S in the lifted state gradually returns to the sheet bundle state prior to being lifted by the air between the sheets being released, but the adhesion between the sheets is still reduced until the sheet bundle resumes its state, so that the sheet feeding operation of the sheets S is started (S15).

That is, the uppermost sheet S of the sheet bundle is fed by the pickup roller 501, and if multi-feeding of sheets S occurs at the separation portion composed of the feed roller 502 and the retard roller 503, separation of sheets is performed. Next, in the second embodiment, it is determined whether feeding of 50 sheets S have been completed as an example of the necessary number of sheets (S16). If feeding of the necessary number of sheets is not completed (S16: No), it is determined whether 10 sheets have been fed as the predetermined number after starting the sheet feeding operation (S17). That is, the processing is repeated until a predetermined number of sheets, i.e., 10 sheets, has been fed after starting the sheet feeding operation (S17: No), and when feeding of the predetermined number of sheets, i.e., 10 sheets, is completed (S17: Yes), the procedure returns to step S12 and the air blowing operation is resumed. In other words, a state in which feeding of the predetermined number of sheets is completed and a state in which feeding of the necessary number of sheets is not ended are set as conditions. Therefore, when these conditions are satisfied during execution of the sheet feed control, the sheet feeding operation is stopped and the air blowing operation is resumed. Thereafter, when the predetermined time has elapsed as described above (S13: Yes), the air blowing operation is stopped (S14), and the sheet feeding operation of the sheet S is started again (S15).

Then, when feeding of the necessary number of sheets, i.e., 50 sheets, is completed after starting and stopping the air blowing operation and repeating the sheet feeding operation of the predetermined number of sheets (S16: Yes), the sheet feed control is ended (S18).

As described, according to the sheet feed control of the second embodiment, the required number of sheets to be printed by the image forming apparatus 201 is greater than the number of sheets that can be separated by one air blowing operation. However, similar to the first embodiment, the air blowing operation is not performed during the sheet feeding operation, such that feeding of sheets with reduced amount of skew can be performed.

In the second embodiment, the number of sheets that can be fed continuously is described as 10, corresponding to the number of sheets that can be separated by one air blowing operation. However, the number of sheets that can be separated by one air bowing operation differs according to the sheet thickness, for example, such that the value of the number of sheets is not limited thereto.

### Third Embodiment

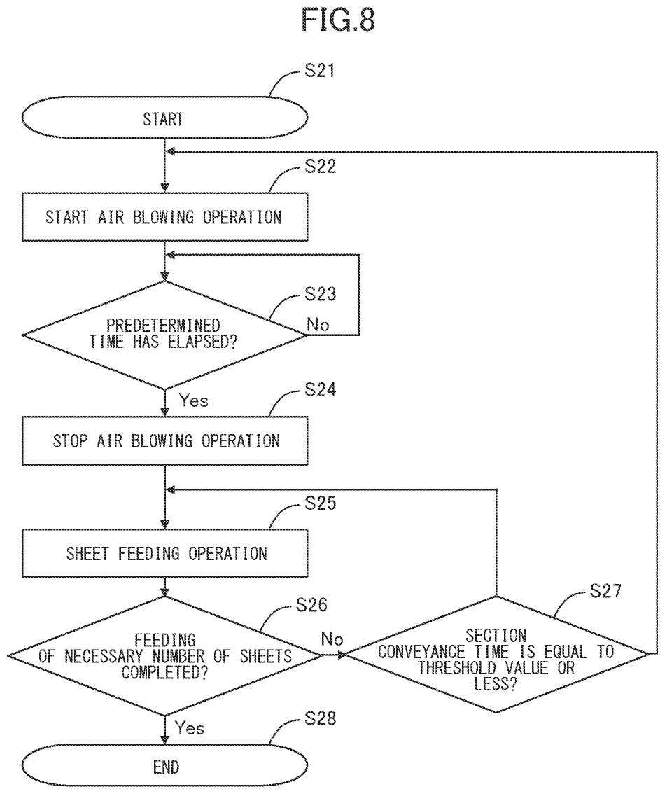

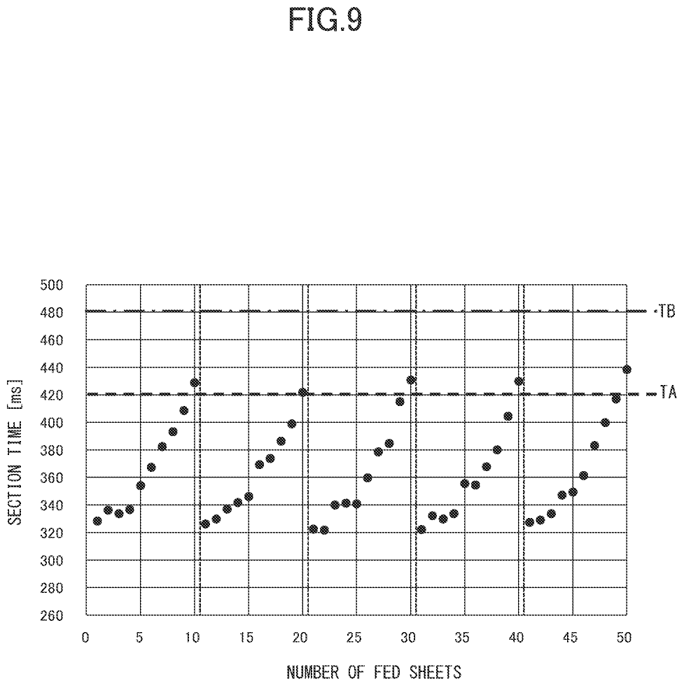

A third embodiment in which a portion of the first and second embodiments has been altered will be described with reference to FIGS. 8 and 9. FIG. 8 is a flowchart illustrating a sheet feed control according to the third embodiment. FIG. 9 is a graph illustrating a relationship between a number of sheets being fed and a section feed time to a sheet detection sensor according to the third embodiment. In the description of the third embodiment, the same reference numbers are used to denote similar portions as the first and second embodiments, and the descriptions thereof are omitted.

The third embodiment illustrates a case in which fifty sheets are fed, for example, as the required number of sheets to be printed by the image forming apparatus 201. As described above, in the air blowing operation, the number of sheets being lifted differs according to the positions of the air blowing nozzles 511a and 512a or the positions of the lift suppressing plates 511c and 512c, but the sheets being lifted by one air blowing operation is limited to approximately a few to tens of sheets. Therefore, similarly as the second embodiment, in a case where 50 sheets are fed, it is not possible to reduce the adhesion between sheets in all 50 sheets by one air blowing operation.

After the air blowing operation has stopped, the sheet lifted by the air blowing operation falls due to its own weight with the elapse of time and the sheets having been separated by air blow returns in to a sheet bundle, such that the adhesion between sheets increases. If the adhesion between sheets is great, the conveyance force of the sheet S by the pickup roller 501 is insufficient, and feeding failure of the sheet S may occur. According to the third embodiment, determination of feeding failure is performed based on a time at which the sheet feed sensor 505 detects the passing of the sheet S (refer to FIGS. 1 to 3). That is, if the sheet S is not detected from the start of driving of the pickup roller 501 to a delay limit time (480 ms), it is determined that feeding failure has occurred. The delay limit time is similar to the time for determining a timeout error in a case where sheets are not fed by the control unit 100.

FIG. 9 is a graph having plotted a section conveyance time per sheet being fed from the starting of drive of the feed motor 520 (refer to FIG. 2) driving the pickup roller 501 to the detection of a leading edge of the sheet S by the sheet feed sensor 505 in the sheet feed deck 500. As described, a delay limit time TB illustrated by a dot-and-dash line is 480 milliseconds (ms), and it corresponds to a delay limit line in which a conveyance sequence cannot be realized if the detection by the sheet feed sensor 505 is delayed from the delay limit time TB. Therefore, according to the third embodiment, a threshold value TA (420 ms) is provided, which is shown by a dashed line serving as a threshold value set to determine whether there is a delay tendency at a time prior to reaching the delay limit time TB (480 ms), that is, a time shorter than the delay limit time TB.

The threshold value TA uses time as a parameter according to the present embodiment, but the threshold value can be described as a value representing a conveyance resistance, that is, adhesion between sheets, that can also be referred to as a threshold value for determining whether a load that occurs when feeding the sheet S by the pickup roller 501 is greater than a set load. In other words, a state in which a load that occurs when feeding the sheet becomes greater than a set load and a state in which feeding of the necessary number of sheets is not completed are set as conditions, and when these conditions are satisfied, the sheet feeding operation can be stopped and the air blowing operation can be resumed.

### Sheet Feed Control According to Third Embodiment

The control unit 100 starts sheet feed control to feed 50 sheets, for example, as the required number of sheets to be printed by the image forming apparatus 201 (S21). At first, the fan motors 511M and 512M (refer to FIG. 2) of the air blow units 511A and 512A are driven, and an air blowing operation of blowing air to the side faces of the sheet bundle is started (S22). Thereby, a few to tens of sheets S on the upper part of the sheet bundle are separated and lifted while the lift suppressing plates 511c and 512c suppresses the lifting of the sheets S (refer to FIG. 4), such that the adhesion between sheets is reduced.

Next, an air blowing operation is performed until a predetermined time has elapsed (S23: No), and when the predetermined time has elapsed (S23: Yes), the air blowing operation is stopped (S24). Thereby, the sheets S in the lifted state gradually returns to the sheet bundle state prior to being lifted by the air between the sheets being released, but the adhesion between the sheets is still reduced until the sheet bundle resumes its state, so that the sheet feeding operation of the sheets S is started (S25).

That is, the uppermost sheet S of the sheet bundle is fed by the pickup roller 501, and if multi-feeding of the sheets S occurs at the separation portion composed of the feed roller 502 and the retard roller 503, separation of sheets is performed. Next, in the third embodiment, whether feeding of 50 sheets S as the necessary number of sheets, for example, has been completed is determined (S26). If feeding of the necessary number of sheets is not completed (S26: No), whether a section conveyance time based on a detection of the sheet feed sensor 505 as described above is equal to or smaller than the threshold value TA is determined (S27). That is, if the section conveyance time is equal to or smaller than the threshold value TA (S27: Yes), the sheet feeding operation is repeated, and if the section conveyance time exceeds the threshold value TA (S27: No), the procedure returns to step S22 and the air blowing operation is resumed. In other words, a state in which the section conveyance time becomes longer than the threshold value TA and a state in which the feeding of the necessary number of sheets is not completed are set as conditions. Therefore, when these conditions are satisfied during execution of the sheet feed control, the sheet feeding operation is stopped and the air blowing operation is resumed. Thereafter, when a predetermined time has elapsed (S23: Yes), the air blowing operation is stopped (S24), and the sheet feeding operation of the sheet S is started again (S25).

When feeding of the necessary number of sheets, i.e., 50 sheets, is completed after starting and stopping the air blowing operation as described above and repeating the sheet feeding operation when the section conveyance time is equal to or smaller than the threshold value TA (S26: Yes), the sheet feed control is ended (S28).

As described above, according to the sheet feed control of the third embodiment, the required number of sheets to be printed by the image forming apparatus 201 is greater than the number of sheets that can be separated by one air blowing operation. However, similar to the first embodiment, since the air blowing operation is not performed during the sheet feeding operation, sheets having less amount of skew can be fed. Then, by determining the delay caused by the increase of conveyance resistance due to adhesion of sheets based on the delay tendency of feed time, and by performing the air blowing operation each time delay is determined, the air blowing operation can be performed again before the conveyance sequence fails.

### Fourth Embodiment

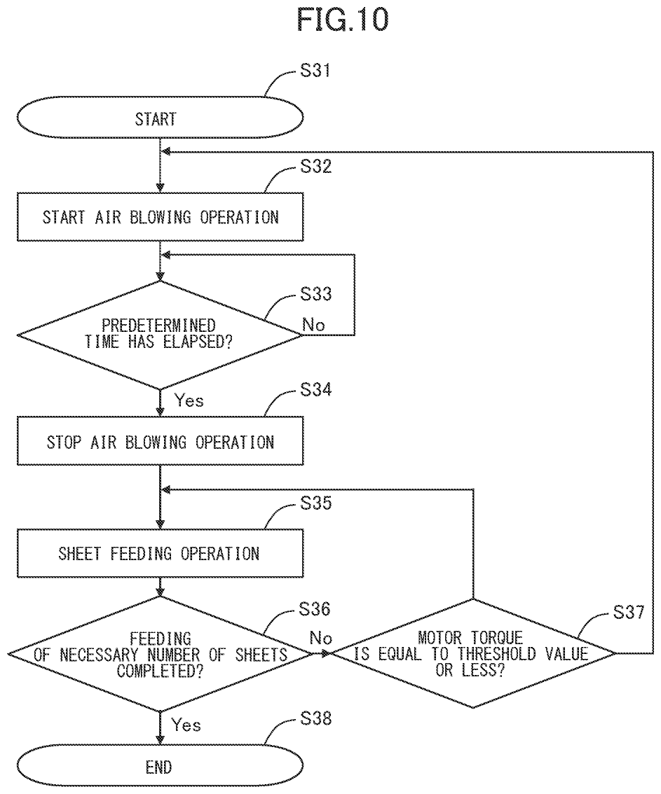

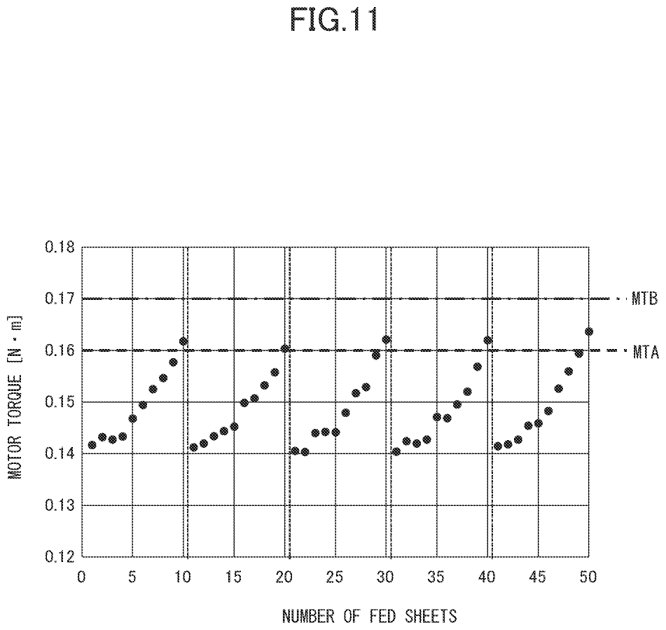

Next, a fourth embodiment in which a part of the first to third embodiments has been altered will be described with reference to FIGS. 10 and 11. FIG. 10 is a flowchart illustrating a sheet feed control according to the fourth embodiment. FIG. 11 is a graph illustrating a relationship between a number of sheets being fed and a motor torque of a feed motor according to the fourth embodiment. In the description of the fourth embodiment, the same reference numbers are used to denote similar portions as the first to third embodiments, and descriptions thereof are omitted.

In the fourth embodiment, a case is illustrated in which 50 sheets are fed, for example, as the required number of sheets to be printed by the image forming apparatus 201. As described above, the number of sheets being lifted by one air blowing operation is limited to a few to tens of sheets. Therefore, similar to the second and third embodiments, if 50 sheets are to be fed, it is not possible to reduce the adhesion among all 50 sheets by one air blowing operation.

The sheets being lifted by the air blowing operation falls due to its own weight with the elapse of time and the sheets having been separated by air blow returns to a sheet bundle, such that the adhesion between sheets increases. If the adhesion between sheets is great, the conveyance force of the sheet S by the pickup roller 501 is insufficient, and feeding failure of the sheet S may occur. According to the fourth embodiment, determination of feeding failure is performed based on the size of a motor torque of the feed motor 520 by the torque measurement unit 520a (refer to FIG. 2). That is, if the motor torque of the feed motor 520 in a state where feeding of the sheet S is performed by the pickup roller 501 is a limit determination torque (0.17 newton meter (Nm)), a feeding failure is determined. The limit determination torque is equivalent to a torque based on which the control unit 100 determines the occurrence of an error using a motor torque that occurs by load in which the pickup roller 501 cannot feed the sheets stably.

FIG. 11 is a graph in which a motor torque measured by the torque measurement unit 520a when sheets S are conveyed by the pickup roller 501 in the sheet feed deck 500 is plotted per sheet being fed. As described above, a limit determination torque MTB illustrated by the dot-and-dash line is 0.17 N·m, and it is a limit torque in which feeding failure is determined to occur in a case where the motor torque measured by the torque measurement unit 520a is greater than the limit determination torque MTB. Therefore, in the fourth embodiment, a threshold value MTA (0.16 N·m) illustrated by a dashed line is provided as a threshold value, i.e., set torque, set to determine that the conveyance resistance has an increasing tendency, prior to reaching the limit determination torque MTB (0.17 N·m). The threshold value MTA (0.16 Nm) can be any torque as long as it is smaller than the limit determination torque MTB.

According to the present embodiment, the threshold value MTA uses torque as the parameter, but in short, the value is a threshold value of conveyance resistance, or adhesion of sheets, and the threshold value is used to determine whether the load that occurs when feeding the sheets S by the pickup roller 501 is greater than a set load. In other words, a state in which the load that occurs when feeding the sheet becomes greater than the set load and a state in which feeding of the necessary number of sheets is not completed are set as the conditions, and when these conditions are satisfied, the sheet feeding operation may be stopped and the air blowing operation may be resumed.

### Sheet Feed Control According to Fourth Embodiment

The control unit 100 starts sheet feed control to feed 50 sheets, for example, as the required number of sheets to be printed by the image forming apparatus 201 (S31). At first, an air blowing operation of driving the fan motors 511M and 512M (refer to FIG. 2) of the air blow units 511A and 512A and blowing air toward the side faces of the sheet bundle is started (S32). Thereby, a few to tens of sheets S at the upper part of the sheet bundle are separated and lifted while the lift suppressing plates 511c and 512c suppress lifting of the sheets S (refer to FIG. 4), such that the adhesion between sheets is reduced.

Next, an air blowing operation is performed until a predetermined time has elapsed (S33: No), and when the predetermined time has elapsed (S33: Yes), the air blowing operation is stopped (S34). Thereby, the sheets S in the lifted state gradually returns to the sheet bundle state prior to being lifted by the air between the sheets being released, but the adhesion between the sheets is still reduced until the sheet bundle resumes its state, so that the sheet feeding operation of the sheets S is started (S35).

That is, the uppermost sheet S of the sheet bundle is fed by the pickup roller 501, and if multi-feeding of the sheets S occurs at the separation portion composed of the feed roller 502 and the retard roller 503, separation of sheets is performed. Next, in the fourth embodiment, whether feeding of 50 sheets S as the necessary number of sheets, for example, has been completed is determined (S36). If feeding of the necessary number of sheets is not completed (S36: No), whether the motor torque of the feed motor 520 based on the measurement of the torque measurement unit 520a is equal to or smaller than the threshold value MTA is determined (S37). That is, if the motor torque is equal to or smaller than the threshold value MTA (S37: Yes), the sheet feeding operation is repeated, and if the motor torque exceeds the threshold value MTA (S37: No), the procedure returns to step S32 and the air blowing operation is resumed. In other words, a state in which the motor torque becomes greater than the threshold value MTA and a state in which the feeding of the necessary number of sheets is not completed are set as conditions. Therefore, when these conditions are satisfied during execution of the sheet feed control, the sheet feeding operation is stopped and the air blowing operation is resumed. Thereafter, when a predetermined time has elapsed (S33: Yes), the air blowing operation is stopped (S34), and the sheet feeding operation of the sheet S is started again (S35).

When feeding of the necessary number of sheets, i.e., 50 sheets, is completed after starting and stopping the air blowing operation as described above and repeating the sheet feeding operation when the motor torque is equal to or smaller than the threshold value MTA (S36: Yes), the sheet feed control is ended (S38).

As described above, according to the sheet feed control of the fourth embodiment, the required number of sheets to be printed by the image forming apparatus 201 is greater than the number of sheets that can be separated by one air blowing operation. However, similar to the first embodiment, since the air blowing operation is not performed during the sheet feeding operation, sheets having less amount of skew can be fed. Then, by determining the increase of conveyance resistance due to adhesion of sheets based on the increase tendency of motor torque of the feed motor 520 and performing the air blowing operation each time in correspondence thereto, the air blowing operation can be resumed before the feeding failure occurs.

### Fifth Embodiment

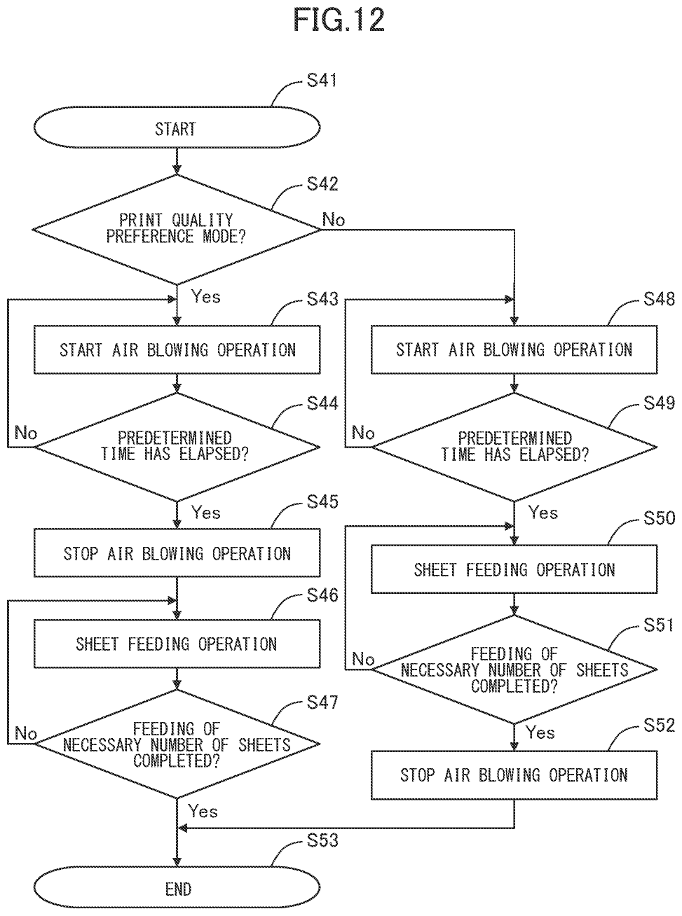

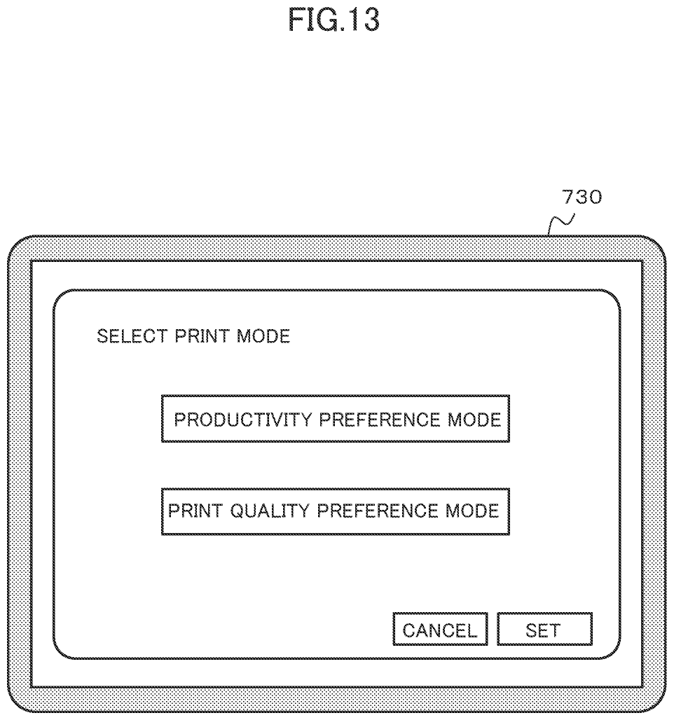

Next, a fifth embodiment in which a part of the first embodiment has been altered will be described with reference to FIGS. 12 and 13. FIG. 12 is a flowchart illustrating a sheet feed control according to the fifth embodiment. FIG. 13 is a view illustrating a mode selection screen according to the fifth embodiment. In the description of the fifth embodiment, the same reference numbers are used to denote similar portions as the first embodiment, and descriptions thereof are omitted.

The first embodiment illustrated a case in which the control unit 100 performs control to execute a mode in which the air blowing operation is performed, and after stopping the air blowing operation, the sheet feeding operation is performed with the air blowing operation stopped. As described, by performing the sheet feeding operation in a state where the air blowing operation is stopped, the sheet skew amount can be reduced and the print quality, that is, image forming quality, can be improved, but the productivity is reduced since the air blowing operation and the sheet feeding operation are performed alternately. Therefore, according to the fifth embodiment, the above-mentioned mode can be executed as a print quality preference mode, i.e., a first mode. In addition, a productivity preference mode, i.e., second mode, can be performed in which the sheet feeding operation is performed simultaneously when performing the air blowing operation even if there is a risk that the skew amount is increased and the print quality is deteriorated. That is, the print quality preference mode and the productivity preference mode can be selectively executed.

### Sheet Feed Control According to Fifth Embodiment

The control unit 100 starts sheet feed control, or sheet feed control mode, to feed 15 sheets, for example, as the required number of sheets to be printed by the image forming apparatus 201 (S41). At first, as illustrated in FIG. 13, a print mode selection screen is displayed on the operation unit 730, and the user is allowed to select the productivity preference mode or the print quality preference mode (S42). If the user selects a print quality preference mode (S42: Yes), the print quality preference mode, which is similar to the control of the first embodiment, is executed.

In the print quality preference mode, at first, the air blowing operation is started in which the fan motors 511M and 512M (refer to FIG. 2) of the air blow units 511A and 512A are driven and air is blown to the side faces of the sheet bundle (S43). Thereby, the ten sheets S on the upper part of the sheet bundle are separated and lifted while the lift suppressing plates 511c and 512c suppresses the lifting of the sheets S (refer to FIG. 4), by which the adhesion between sheets is reduced.

Next, the air blowing operation is performed until a predetermined time has elapsed (S44: No), and when a predetermined time has elapsed (S44: Yes), the air blowing operation is stopped (S45). Thereby, the sheet S in the lifted state gradually returns to the sheet bundle state prior to being lifted by the air between the sheets being released, but the adhesion between the sheets is still reduced until the sheet bundle resumes its state, so that the sheet feeding operation of the sheets S is started (S46).

That is, the uppermost sheet S of the sheet bundle is fed by the pickup roller 501, and if multi-feeding of the sheets S occurs at the separation portion composed of the feed roller 502 and the retard roller 503, separation of sheets is performed. Next, the sheet feeding operation is repeated until the feeding of 15 sheets S as the necessary number of sheets, for example, is completed (S47: No), and when the feeding of the necessary number of sheets is completed (S47: Yes), the sheet feed control is ended (S53).

Meanwhile, in the above-mentioned step S42, if a mode other than the print quality preference mode, that is, a productivity preference mode, is selected (S42: No), the productivity preference mode is executed.

In the productivity preference mode, at first, the air blowing operation of driving the fan motors 511M and 512M (refer to FIG. 2) of the air blow units 511A and 512A and blowing air to the side faces of the sheet bundle is started (S48). Thereby, 10 sheets S on the upper part of the sheet bundle are separated and lifted while the lift suppressing plates 511c and 512c suppress the lifting of the sheets S (refer to FIG. 4), by which the adhesion between the sheets is reduced.

Next, the system is set to standby while performing air blowing operation until a predetermined time has elapsed (S49: No), and when a predetermined time has elapsed (S49: Yes), lifting of the sheet S is stabilized, such that the sheet feeding operation of the sheets S is started while continuing the air blowing operation (S50). That is, the uppermost sheet S of the sheet bundle is fed by the pickup roller 501, and if multi-feeding of the sheets S occurs at the separation portion composed of the feed roller 502 and the retard roller 503, separation of sheets is performed. Next, the sheet feeding operation is repeated until the feeding of 15 sheets S as the necessary number of sheets, for example, is completed (S51: No), and when the feeding of the necessary number of sheets is completed (S51: Yes), the air blowing operation is stopped (S52), and the sheet feed control is thereby ended (S53).

As described, according to the fifth embodiment, the item to be prioritized among productivity, i.e., printing time, and print quality can be switched according to the determination of the user. Then, by controlling the air blowing operation and the sheet feeding operation according to the mode selected by the user, it becomes possible to correspond to various cases of use.

According to the fifth embodiment, it has been described that a same control as the sheet feed control according to the first embodiment is performed as the print quality preference mode, but the present technique is not limited thereto, and for example, the same control as the sheet feed control according to the second to fourth embodiments can also be performed.

### Other Embodiments

Further according to the first to fifth embodiments described above, a sheet feed control in the sheet feed deck 500 equipped with the air blow units 511A and 512A was described. However, the present technique is not limited thereto, and for example, sheet feed control according to the present embodiment can be performed in the sheet feed unit 230 having the sheet feed cassette 1 or the manual sheet feed portion 235 having the manual feed tray 6 equipped with an air blow unit. Further, when the sheet feed control according to the present embodiment is performed in the sheet feed unit 230, the control can be performed in any step in the vertical direction. That is, the sheet supporting portion supporting the sheet bundle can adopt any configuration.

Further, the first to fifth embodiments have been described as having a pickup roller for feeding sheets and a feed roller and a retard roller for separating sheets subjected to multi-feeding, by which feeding and separating sheets are controlled. However, the present technique is not limited thereto, and the configuration of the sheet feed portion for feeding sheets can be any configuration, such as feeding sheets by performing vacuum suction of the sheet to a belt.

Further, the third and fourth embodiments have been described as performing the air blowing operation again when the increase of adhesion between sheets is determined based on the feed time of sheets or the motor torque. However, the present technique is not limited to these examples, and it is possible to adopt a configuration in which the sheet conveyance load is either directly detected or computed based on the feed time or the motor torque to determine the increase of adhesion between sheets.

Moreover, the first to fifth embodiments have been described based on the control unit 100 being equipped in the image forming apparatus 201. However, the present technique is not limited thereto, and the control unit can be equipped in the sheet feed deck 500, that is, the control unit can be arranged on any device as long as the control unit capable of controlling the sheet feed portion and the air blow unit is electrically connected to these components.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-003466, filed Jan. 13, 2022, which is hereby incorporated by reference herein in its entirety.

What is claimed is:

1. A sheet feeding apparatus comprising:
a sheet supporting portion configured to support a sheet bundle;
a sheet feed portion configured to perform a sheet feeding operation by abutting against an uppermost sheet of the sheet bundle supported on the sheet supporting portion and feeding the uppermost sheet;
an air separation unit configured to perform an air blowing operation of blowing air to a side face of the sheet bundle supported on the sheet supporting portion and separating sheets; and
a control unit configured to execute a mode of performing the air blowing operation by the air separation unit, stopping the air blowing operation, and then performing the sheet feeding operation by the sheet feed portion in a state where the air blowing operation is stopped.

2. The sheet feeding apparatus according to claim 1, wherein, in a case where a set condition is satisfied during execution of the mode, the control unit stops the sheet feeding operation by the sheet feed portion, performs the air blowing operation by the air separation unit, stop the air blowing operation, and thereafter, resumes the sheet feeding operation by the sheet feed portion in the state where the air blowing operation is stopped.

3. The sheet feeding apparatus according to claim 2, wherein the set condition is satisfied in a case where a predetermined number of sheets is fed in the sheet feeding operation by the sheet feed portion and where feeding of a necessary number of sheets is not completed.

4. The sheet feeding apparatus according to claim 2, further comprising a sheet detection unit configured to detect a sheet at a position downstream of the sheet feed portion in a sheet feeding direction,
wherein the set condition is satisfied in a state where a feed time is longer than a set time and where feeding of a necessary number of sheets is not completed, and
wherein the feed time is a time from feeding of the sheet by the sheet feed portion to detection of the sheet at the sheet detection unit.

5. The sheet feeding apparatus according to claim 2,
wherein the sheet feed portion includes a sheet feed roller configured to abut against the uppermost sheet and feed a sheet, and a motor configured to drive the sheet feed roller, and
wherein the set condition is satisfied in a case where a motor torque that is output when the sheet feed portion feeds the sheet is greater than a set torque and where feeding of a necessary number of sheets is not completed.

6. The sheet feeding apparatus according to claim 2, wherein the set condition is satisfied in a case where a load that occurs when the sheet feed portion feeds a sheet is greater than a set load and where feeding of a necessary number of sheets is not completed.

7. The sheet feeding apparatus according to claim 1, wherein, the control unit is configured to perform the air blowing operation by the air separation unit for a predetermined time before stopping the air blowing operation in the mode.

8. The sheet feeding apparatus according to claim 1,
wherein the mode is a first mode, and
wherein the control unit is configured to execute the first mode, and a second mode in which the sheet feeding operation is performed while the air blowing operation is performed by the air separation unit.

9. The sheet feeding apparatus according to claim 1, wherein the air separation unit includes a fan configured to blow air, and a nozzle configured to guide the air blown by the fan to the side face of the sheet bundle supported on the sheet supporting portion.

10. An image forming system comprising:
the sheet feeding apparatus according to claim 1; and
an image forming unit configured to form an image on a sheet fed from the sheet feeding apparatus.
